(19) United States
(12) Patent Application Publication
(10) Pub. No.: US 2006/0218918 A1
(43) Pub. Date: Oct. 5, 2006

(54) Pyrotechnic actuator

(75) Inventors: Masato Hirooka, Tatsuno-Shi (JP); Nobuyuki Katsuda, Tatsuno-Shi (JP); Naoki Matsuda, Tatsuno-Shi (JP)

Correspondence Address: BIRCH STEWART KOLASCH & BIRCH, PO BOX 747, FALLS CHURCH, VA, 22040-0747, US

(73) Assignee: Daicel Chemical Industries, Ltd., Sakai-Shi (JP)

(21) Appl. No.: 11/375,030

(22) Filed: Mar. 15, 2006

Related U.S. Application Data
(60) Provisional application No. 60/663,224, filed on Mar. 21, 2005.

(30) Foreign Application Priority Data
Mar. 16, 2005 (JP) 2005-74228

(51) Int. Cl. F01B 29/00; B60R 21/34

(52) U.S. Cl. 60/512; 180/274

(57) ABSTRACT

The present invention provides a pyrotechnic actuator comprising a cylindrical housing, both ends of which are open, an electric ignition device disposed to block an opening portion at one end of the cylindrical housing, and a piston and piston rod inserted into the cylindrical housing to be capable of an axial motion, the cylindrical housing having in a peripheral surface thereof a gas discharge port, the gas discharge port being blocked by the piston prior to activation and opened by the motion of the piston after activation.

This non-provisional application claims priority under 35 U.S.C. § 119(a) on Patent Application No. 2005-74228 filed in Japan on 16 Mar. 2005 and 35 U.S.C. § 119(c) on U.S. Provisional Application No. 60/663224 filed on 21 Mar. 2005, which are incorporated by reference.

### BACKGROUND OF THE INVENTION

1. Field of the Invention

The present invention relates to a pyrotechnic actuator that can be used in a human restraining apparatus installed in an automobile.

2. Description of the Related Art

In addition to air bag type restraining apparatuses used in vehicles as passenger restraining apparatuses and pedestrian protecting apparatuses, apparatuses for raising the hood of the vehicle at a collision in order to protect pedestrians and apparatuses for retracting the steering wheel (drawing the steering wheel into the front of the vehicle), for example, also exist.

These apparatuses employ a pyrotechnic type actuator in which a piston is moved using the force of an explosive. The explosive energy is transmitted to the piston as pressure, and therefore pressure is applied to the apparatus itself at any stage after activation of the actuator.

In US-A No. 2003/0167959, an igniter 6, a piston 8, and a piston rod 9 are disposed in a housing 2, 3, and an O-ring 15 is disposed on a peripheral wall portion of the piston 8. When the igniter 6 is activated, the piston 8 is pushed such that the piston rod 9 protrudes from the housing 2, 3.

### SUMMARY OF THE INVENTION

The present invention relates to a pyrotechnic actuator comprising a cylindrical housing, both ends of which are open, an electric ignition device disposed to block an opening portion at one end of the cylindrical housing, and a piston and piston rod inserted into the cylindrical housing to be capable of an axial motion,

the cylindrical housing having in a peripheral surface thereof a gas discharge port, the gas discharge port being blocked by the piston prior to activation and opened by the motion of the piston after activation.

### BRIEF DESCRIPTION OF THE DRAWINGS

The present invention will become more fully understood from the detailed description given hereinbelow and the accompanying drawings which are given by way of illustration only, and thus are not limitative of the present invention and wherein:

FIG. 1 shows a longitudinal sectional view of a pyrotechnic actuator;

FIG. 2 shows a longitudinal sectional view of a pyrotechnic actuator according to another embodiment;

FIG. 3 shows a longitudinal sectional view of a pyrotechnic actuator according to another embodiment; and

FIG. 4 shows a view showing an example of a human protecting apparatus using the pyrotechnic actuator of FIG. 1.

### DETAILED DESCRIPTION OF THE INVENTION

In US-A No. 2003/0167959, when gas is generated upon activation of the igniter 6, thereby pushing the piston 8 such that the piston rod 9 protrudes, the gas cannot escape, and therefore the interior of the housing 2, 3 remains in a pressurized state. If the pyrotechnic actuator is removed from the vehicle body with the housing 2, 3 in this pressurized state, fragments and the like may fly out due to the pressure release, causing injury to the operator. Hence, in consideration of operational safety when dismantling a vehicle body, it is preferable that this pressurized state not be maintained.

An aspect of the present invention is to provide a pyrotechnic actuator in which pressure is released after a operation due to gas pressure in order to increase operational safety in dismantling a vehicle body.

The widthwise cross-section, which is made by cutting the actuator in a radial direction, of the cylindrical housing preferably takes a circular form, but if necessary may take a triangular or square form, a pentagonal, hexagonal, or other polygonal form, or an elliptical form. The widthwise sectional form of the piston and piston rod is set depending on the widthwise sectional form of the cylindrical housing.

The electric ignition device may be a well-known electric igniter alone, or a combination of an electric igniter and a small amount of a gas generating agent.

The pyrotechnic actuator of the present invention has a gas discharge port in the peripheral surface of the cylindrical housing, and the gas discharge port is blocked prior to activation of the electric ignition device and opened after activation. Hence, when the electric ignition device is activated, the piston performs a predetermined operation (an axial motion) , whereupon gas is discharged through the open gas discharge port. As a result of this gas discharge, the space between the electric ignition device and piston are under a reduced pressure state (normal or near-normal pressure), and the piston returns to its pre-activation state, thereby blocking the gas discharge port. Thus the pressurized state is released, and operational safety during dismantling of the vehicle is ensured.

Further, by adjusting the opening area of the gas discharge port, the gas discharge time (the amount of gas that is discharged per unit time) can be adjusted, and accordingly, the axial reciprocation time of the piston and piston rod can also be adjusted. Reciprocation denotes a process whereby, upon activation of the electric ignition device, the piston and piston rod perform a linear motion up to a maximum movement limit and then return to their original position. Note that the gas discharge port is preferably either formed in a plurality at equal intervals in the peripheral surface of the housing, or disposed such that the thrust generated when gas is discharged through the gas discharge port can be counterbalanced.

The present invention relates to the pyrotechnic actuator, wherein the piston has an outer diameter which is similar to an inner diameter of the cylindrical housing and larger than a diameter of the opening portion of the cylindrical housing, and

the piston rod is formed integrally with the piston and has an outer diameter that is smaller than the diameter of the opening portion of the cylindrical housing.

By correlating the diameter of the piston with the opening portion diameter of the cylindrical housing, the piston can be prevented from flying out of the cylindrical housing after activation.

The present invention relates to the pyrotechnic actuator, wherein the cylindrical housing comprises an inward-facing flange portion on the opening portion side, and the inward-facing flange portion has a gas escape hole.

When the electric ignition device is activated such that the piston and piston rod perform a linear motion, air existing in the space surrounded by the piston, piston rod, and cylindrical housing (air which enters the actuator during manufacture) is compressed and thereby raised in pressure. As a result, this air acts to suppress the linear motion of the piston and piston rod. The pressure applied to the piston upon activation of the electric ignition device is considerably higher than the compressive force of the aforementioned space, but as long as air continues to exist in this space, the air generates resistance to the linear motion of the piston and piston rod. By providing the gas escape hole in the inward-facing flange portion, the space is maintained at normal pressure, and therefore the linear motion of the piston and piston rod progresses smoothly. Note that the movement speed of the piston and piston rod can be adjusted by adjusting the opening area of the gas escape hole.

The present invention relates to the pyrotechnic actuator, wherein the gas escape hole provided in the inward-facing flange portion is blocked by a sealing tape.

When the electric ignition device is activated such that the piston and piston rod perform a linear motion, the space surrounded by the piston, piston rod, and cylindrical housing is compressed and thereby raised in pressure. This pressure acts to suppress the linear motion of the piston and piston rod. However, when the space reaches a predetermined pressure (a sealing tape rupturing strength), the sealing tape ruptures, opening the gas escape hole provided in the inward-facing flange portion. As a result, the internal pressure of the space falls, and the linear motion of the piston and piston rod progresses smoothly. This structure is suitable for use in a case where the movement speed of the piston is changed during an operation.

The timing for rupturing the sealing tape to open the gas escape hole is set by adjusting the strength (thickness, material, adhesive, and so on) of the sealing tape and the diameter of the gas escape hole.

The present invention relates to the pyrotechnic actuator, further having a device for preventing the piston from moving before activation of the pyrotechnic actuator.

By providing such a device, the piston can be prevented from flying out of the cylindrical housing before activation due to vibration or the like applied to the pyrotechnic actuator during normal vehicle traveling.

The pyrotechnic actuator of the present invention may be used in various human restraining apparatuses installed in an automobile. Here, the term “human” encompasses both automobile passengers and pedestrians.

In the pyrotechnic actuator of the present invention, a pressurized part exists at the time of activation, but no pressurized part exists after activation. Hence, when the pyrotechnic actuator is removed from a vehicle, problematic situations, in which fragments fly out and injure an operator due to the pressure release that occurs when a pressurized part exists, do not arise.

### PREFERRED EMBODIMENTS OF THE INVENTION

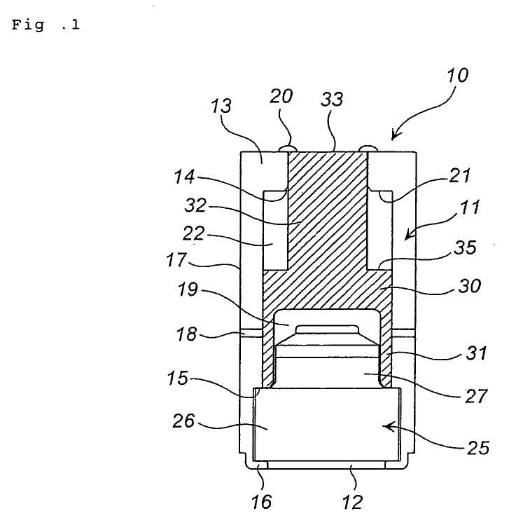

(1) Pyrotechnic Actuator of FIG. 1

FIG. 1 is a longitudinal sectional view of a pyrotechnic actuator 10.

An electric igniter 25 is mounted in a metallic, cylindrical housing 11 having a circular widthwise cross-section so as to block an opening portion 12 on one end side of the cylindrical housing 11. An inward-facing flange portion 13 is formed on the other end side of the cylindrical housing 11, and a part surrounded by the inward-facing flange portion 13 is defined as an opening portion 14.

The electric igniter 25 has an igniter collar 26 and an ignition portion 27. The electric igniter 25 is fitted into the cylindrical housing 11 such that the igniter collar 26 abuts against a step portion 15 provided on an inner peripheral surface of the cylindrical housing 11, and is fixed to the cylindrical housing 11 by crimping a peripheral edge (crimping portion 16) of the opening portion 12 at one end side.

A plurality of (for example, between two and ten, and preferably between two and six) gas discharge ports 18 are provided in a peripheral surface 17 of the cylindrical housing 11 at equal intervals in the circumferential direction. The diameter of the gas discharge ports 18 is determined in consideration of the relationship with the reciprocation time of a piston 30 and so on, and may be set between 0.5 and 3 mm, for example, and preferably between 1 and 2 mm.

The metallic piston 30 is capable of an axial motion within the cylindrical housing 11. The outer diameter of the piston 30 is approximately identical to or slightly smaller than the inner diameter of the cylindrical housing 11, and larger than the diameter of the opening portion 14. Accordingly, the piston 30 may perform a sliding motion with the outer peripheral surface of the piston 30 in contact with the inner peripheral surface of the cylindrical housing 11, or may move with a slight gap existing between the outer peripheral surface of the piston 30 and the inner peripheral surface of the cylindrical housing 11. In either case, a lubricant may be interposed between the outer peripheral surface of the piston 30 and the cylindrical housing 11 to enable the piston 30 to move smoothly. In the pyrotechnic actuator 10, the piston 30 performs only a single reciprocation, and therefore sliding does not pose a problem.

The piston 30 has a cylindrical skirt portion 31 on its lower portion. The ignition portion 27 of the electric igniter 25 is positioned within a columnar space 19 surrounded by the skirt portion 31, and an open end face of the skirt portion 31 abuts against the igniter collar 26. By fitting the skirt portion 31 and electric igniter 25 together in this manner, the piston 30 is held in position. The outer peripheral surface of the skirt portion 31 directly opposes the gas discharge ports 18 either in close proximity thereto or in contact therewith, and thus the gas discharge ports 18 are blocked.

A metallic piston rod 32 is formed integrally with the piston 30. The outer diameter of the piston rod 32 is smaller than the outer diameter of the piston 30, and approximately identical to or slightly smaller than the diameter of the opening portion 14 in the cylindrical housing. Accordingly, the piston rod 32 may perform a sliding motion with the outer peripheral surface of the piston rod 32 in contact with the opening portion 14, or may move with a slight gap existing between the outer peripheral surface of the piston rod 32 and the opening portion 14. In either case, a lubricant may be interposed between the outer peripheral surface of the piston rod 32 and the opening portion 14. In the pyrotechnic actuator 10, the piston rod 32 performs only a single reciprocation, and therefore sliding does not pose a problem.

A top face 33 of the piston rod 32 is flat and coplanar with the inward-facing flange portion 13. Axial movement of the piston 30 and piston rod 32 prior to activation is prevented by crimping an opening peripheral edge (crimping portion 20) of the inward-facing flange portion 13 (opening portion 14). Note that the top face 33 of the piston rod 32 may protrude outward from the opening portion 14 prior to activation, and also that a cylindrical space 22 between the piston rod 32 and cylindrical housing 11 is at normal pressure.

In FIG. 1, the top face 33 of the piston rod 32 is flat, but the top face 33 may be inclined or curved depending on the application of the human restraining apparatus, more specifically, in accordance with the shape of another member which the top face 33 contacts. In addition, irregularities may be formed on a part or all of the flat, inclined, or curved surface.

Next, an operation of the pyrotechnic actuator 10 will be described. When the electric igniter 25 is activated, gas (or heat, shock waves, and so on) is generated, causing the internal pressure of the columnar space 19 to rise. Upon reception of this increase in the internal pressure of the columnar space 19, the piston 30 performs an axial motion, breaking through the crimping portion 20 such that the piston rod 32 protrudes from the opening portion 14. At this time, the cylindrical space 22 is compressed, leading to a pressure increase therein, and by sufficiently raising the pressure generated through activation of the electric igniter 25, the piston rod 32 can protrude from the upper surface of the cylindrical housing 11 by a sufficient amount. The piston rod 32 stops moving when a shoulder portion 35 of the piston 30 impinges on an inner surface 21 of the inward-facing flange portion 13 (movement halted state=maximum movement state).

During this process, the skirt portion 31 of the piston 30 also performs an axial motion, thereby expanding the volume of the columnar space 19 and opening the gas discharge ports 18. Thus, the high-pressure gas in the columnar space 19 is discharged through the gas discharge ports 18, and as a result, the internal pressure of the columnar space 19 decreases. When the internal pressure of the columnar space 19 is no longer sufficient to support the piston 30 and piston rod 32, and also as a result of the internal pressure of the cylindrical space 22, the piston 30 and piston rod 32 descend to their pre-activation states. At this time, the internal pressure of the columnar space 19 has decreased to normal pressure or near-normal pressure (no pressurized part exists), and therefore operational safety during dismantling is ensured.

By adjusting one or both of the output power of the electric igniter 25 and the total opening area of the gas discharge ports 18, the reciprocation time of the piston 30 and piston rod 32 (the time required from the pre-activation state to the movement halted state and back to the pre-activation state) can be adjusted. The total opening area of the gas discharge ports 18 is adjusted by adjusting the diameter and/or number of the gas discharge ports 18.

In FIG. 1, for example, when the total opening area of the gas discharge ports 18 is increased (and the output power of the electric igniter 25 remains constant) , the amount of gas, that is discharged when the gas discharge ports 18 are opened by the motion of the piston 30 and piston rod 32, increases, and therefore the time required from the movement halted state to the descent of the piston 30 and piston rod 32 (the reciprocation time of the piston) is shortened. On the other hand, when the total opening area of the gas discharge ports 18 is reduced, the reciprocation time of the piston is lengthened.

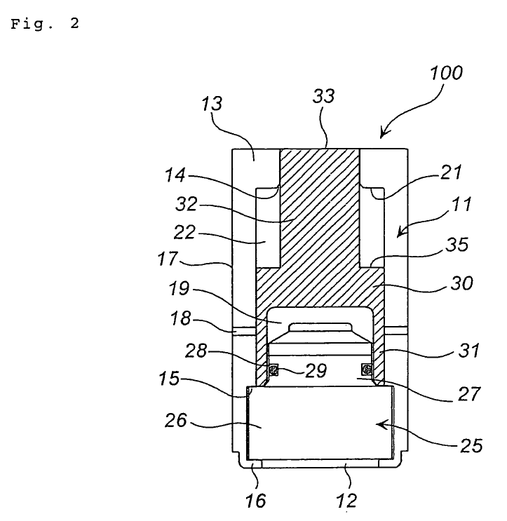

(2) Pyrotechnic Actuator of FIG. 2

FIG. 2 is a longitudinal sectional view of a pyrotechnic actuator 100. The pyrotechnic actuator 100 shown in FIG. 2 has a substantially identical structure to the pyrotechnic actuator 10 shown in FIG. 1, and therefore only different parts will be described. Identical reference numerals to those used in FIG. 1 denote identical components in FIG. 2.

In FIG. 2, an annular groove 28 is provided in the peripheral surface of the ignition portion 27 of the electric igniter 25, and an O-ring 29 is fitted into the annular groove 28. The O-ring 29 is made of rubber or plastic, and contacts the inner peripheral surface of the skirt portion 31 of the piston 30. The frictional force that is generated by the contact between the O-ring 29 and the inner peripheral surface of the skirt portion 31 acts to prevent axial movement of the piston 30 and piston rod 32 prior to activation. The crimped portion 20 of FIG. 1 is not provided, but the O-ring 29 and crimped portion 20 may be used together.

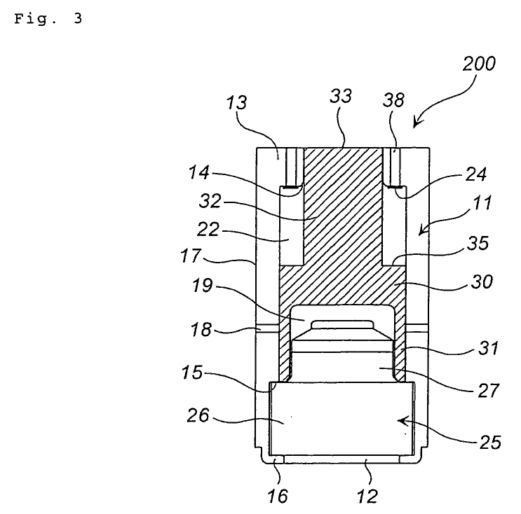

(3) Pyrotechnic Actuator of FIG. 3

FIG. 3 is a longitudinal sectional view of a pyrotechnic actuator 200. The pyrotechnic actuator 200 shown in FIG. 3 has a substantially identical structure to the pyrotechnic actuator 10 shown in FIG. 1, and therefore only different parts will be described. Identical reference numerals to those used in FIG. 1 denote identical components in FIG. 3.

A gas escape hole 38 is provided in the inward-facing flange portion 13. An annular sealing tape 24 is adhered to the gas escape hole 38 from the inner surface 21, shown in FIG. 1. Aluminum or stainless steel tape having an adhesive layer may be employed as the sealing tape 24. The rupture timing of the sealing tape 24 can be adjusted by correlating the thickness, material, adhesive type, and so on of the sealing tape 24 with the diameter of the gas escape hole 38. Note that the gas escape hole 38 may be left open instead of adhering the sealing tape 24 thereto.

Next, an operation of the pyrotechnic actuator 200 will be described. When the electric igniter 25 is activated, gas (or heat, shock waves, and so on) is generated, causing the internal pressure of the columnar space 19 to rise. Upon reception of this increase in the internal pressure of the columnar space 19, the piston 30 is pushed to perform an axial motion, in response to which the piston rod 32 also performs an axial motion so as to protrude from the opening portion 14.

As a result of the motion of the piston 30, the cylindrical space 22 is compressed, leading to an increase in pressure. When the sealing tape 24 is no longer able to resist this pressure increase, it ruptures, thereby opening the gas escape hole 38 such that the internal pressure of the cylindrical space 22 decreases rapidly. As a result, the linear motion of the piston 30 and piston rod 32 progresses rapidly until the shoulder portion 35 of the piston 30 impinges on the inner surface 21 of the inward-facing flange portion 13.

During this process, the skirt portion 31 of the piston 30 also performs an axial motion, thereby expanding the volume of the columnar space 19 and opening the gas discharge ports 18. Thus, the high-pressure gas in the columnar space 19 is discharged through the gas discharge ports 18, and as a result, the internal pressure of the columnar space 19 decreases. When the internal pressure of the columnar space 19 is no longer sufficient to support the piston 30 and piston rod 32, the piston 30 and piston rod 32 descend to their pre-activation states. At this time, the internal pressure of the columnar space 19 has decreased to normal pressure or near-normal pressure, and therefore operational safety during dismantling is ensured.

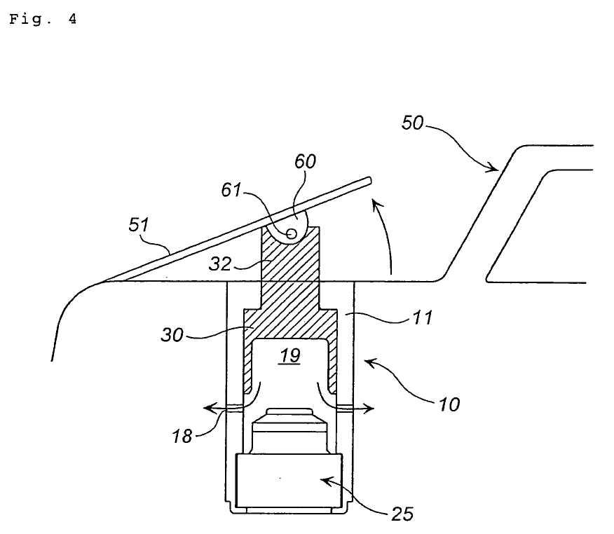

(4) Example Using Pyrotechnic Actuator of FIG. 1 (FIG. 4)

FIG. 4 is a view showing an example of a pedestrian protecting apparatus (hood lifting apparatus) using the pyrotechnic actuator 10 of FIG. 1. Note that the piston rod 32 is connected to a fitting 60, and therefore protrudes slightly from the opening portion 14 of the cylindrical housing 11 prior to activation. FIG. 4 merely illustrates an operation performed using the pyrotechnic actuator 10, and does not reflect actual dimensions.

One pyrotechnic actuator 10 is provided on each side of the width direction of a vehicle 50 (although only one pyrotechnic actuator 10 is illustrated in the drawing). The piston rod 32 is joined to a hood 51 by a rod-form support 61 which is clamped from both sides by two substantially semicircular fittings 60 (only one of which is shown in the drawing) fixed to predetermined positions on the hood 51, and held between the two fittings 60 in the width direction of the vehicle 50 so as to be capable of rotating without falling. The fitting 60 may have a curved surface corresponding to the peripheral surface form of the piston rod 32. Alternatively, a flat-plate shaped fitting 60 may be used, and the piston rod 32 which contacts the fitting 60 may take a partially planar form.

By connecting the piston rod 32 and hood 51 using the fitting 60 and support 61 in this manner, the hood 51 can be supported at an optional angle when the piston rod 32 rises.

When the front surface of the vehicle 50 collides with a pedestrian, the electric igniter 25 is activated by a command issued from an impact detection sensor and an electronic control unit (ECU), and as a result, the piston 30 and piston rod 32 rise. Thus the hood 51, which is in contact with the piston rod 32, is raised rapidly. FIG. 4 shows a state in which the piston rod 32 is raised to its upper limit.

When the front surface of the vehicle 50 collides with a pedestrian, the pedestrian is often lifted onto and slammed against the hood 51. In this case, although the hood 51 itself is soft, engine components such as a cylinder block and cam cover installed directly beneath the hood 51 are hard, and hence when the pedestrian is slammed against the hood 51, he or she may collide with these hard components via the hood 51, increasing the seriousness of the injury.

However, when the pyrotechnic actuator 10 is activated as shown in FIG. 4, the hood 51 flies up, forming a space between the hood 51 and the hard components, and as a result, the shock suffered by the pedestrian when slammed against the hood 51 is greatly alleviated.

After a predetermined time period (a time period derived from past accident data and the like which is sufficiently long to ensure that the pedestrian is protected), the piston rod 32 returns to its pre-activation position, and hence the hood 51 also returns to its original state. It is assumed that the pedestrian is no longer in contact with the hood 51 at this time, and therefore protection of the pedestrian is achieved to a sufficient extent. Moreover, gas discharge through the gas discharge ports 18 acts to enhance the cushioning effect when the pedestrian strikes the hood 51, and hence the shock suffered by the pedestrian is further alleviated.

When the operation of the pyrotechnic actuator 10 is complete, the interior of the columnar space 19 returns to normal or near-normal pressure. As a result, no pressurized part exists when the pyrotechnic actuator 10 is removed during dismantling of the vehicle 50 after the accident, and therefore operational safety is ensured.

The invention thus described, it will be obvious that the same may be varied in many ways. Such variations are not to be regarded as a departure from the spirit and scope of the invention, and all such modification as would be obvious to one skilled in the art are intended to be included within the scope of the following claims.

1. A pyrotechnic actuator comprising a cylindrical housing, both ends of which are open, an electric ignition device disposed to block an opening portion at one end of the cylindrical housing, and a piston and a piston rod, inserted into the cylindrical housing to be capable of an axial motion, the cylindrical housing having in a peripheral surface thereof a gas discharge port, the gas discharge port being blocked by the piston prior to activation and opened by the motion of the piston after activation.

2. The pyrotechnic actuator according to claim 1, wherein the piston has an outer diameter which is similar to an inner diameter of the cylindrical housing and larger than a diameter of another opening portion of the cylindrical housing, and the piston rod is formed integrally with the piston and has an outer diameter that is smaller than the diameter of said another opening portion of the cylindrical housing.

3. The pyrotechnic actuator according to claim 1, wherein the cylindrical housing comprises an inward-facing flange portion on a side of said another opening portion, and the inward-facing flange portion has a gas escape hole.

4. The pyrotechnic actuator according to claim 3, wherein the gas escape hole provided in the inward-facing flange portion is blocked by a sealing tape.

5. The pyrotechnic actuator according to claim 1, further comprising a device for preventing the piston from moving before activation of the pyrotechnic actuator.

6. A pyrotechnic actuator, comprising:
a cylindrical housing including a first end and a second end opposite to the first end;
an electric ignition device provided in the first end;
an opening provided in the second end;
a piston and a piston rod provided within the cylindrical housing to be capable of sliding movement in an axial direction of the cylindrical housing such that the piston rod is engagement with the opening; and
a gas discharge port formed in a peripheral portion of the cylindrical housing, the gas discharge port being closed by the piston prior to activation and open after activation.

7. The pyrotechnic actuator according to claim 6, wherein the piston has an outer diameter which corresponds to an inner diameter of the cylindrical housing and larger than a diameter of the opening, and the piston rod is formed integrally with the piston and has an outer diameter that is smaller than the diameter of the opening.

8. The pyrotechnic actuator according to claim 6, wherein the opening is defined by a flange portion provided in the second end and extending inwardly, and the flange portion includes a gas escape hole.

9. The pyrotechnic actuator according to claim 8, wherein the gas escape hole is covered by a sealing tape.

10. The pyrotechnic actuator according to claim 5, further comprising:
a member provided in the cylindrical housing and physically contacting the piston or the piston rod and preventing the piston or piston rod from moving before activation of the pyrotechnic actuator.
